(19) United States
(12) Patent Application Publication
(10) Pub. No.: US 2005/0146145 A1
(43) Pub. Date: Jul. 7, 2005

(54) Handle, in particular for motor vehicle doors

(76) Inventors: Matthias Koch, Hardel (DE); Gerrit Kirsch, Mulheim (DE); Ralf Hohn, Velbert (DE); Frank Rode, Erkelenz (DE); Dirk Muhlhaus, Velbert (DE)

Correspondence Address: Martin A Farber, Suite 473, 866 United Nations Plaza, New York, NY, 10017, US

(21) Appl. No.: 10/497,136

(22) PCT Filed: Dec. 11, 2002
(86) PCT No.: PCT/EP02/14090

(30) Foreign Application Priority Data
Dec. 12, 2001 (DE) 101-61-194.3
Feb. 14, 2002 (DE) 102-06-632.9
Dec. 4, 2002 (DE) 102-56-842.1

(51) Int. Cl. E05C 3/06

(52) U.S. Cl. 292/216

(57) ABSTRACT

Handle, suitable for a motor vehicle door, having a visible and a grip part (1) and a plurality of functional parts, which functional parts comprise a handle pivot bearing (9, 9′) and an electronic component (8; 18, 19), the functional parts being plugged together with the grip part (1), and wherein the electronic component is positioned in a cavity (7) of the grip part (1) and has a plug (12) disposed in a region of the pivot bearing; wherein the electronic component (8; 18, 19), which is fixedly connected to the plug (12), is plugged into the handle cavity (7) through a pivot-bearing-side opening of the grip part (1), and this opening is closed by a functional part forming the handle pivot bearing (9, 9′).

The invention relates to a handle, in particular for motor vehicle doors, having a visible and grippable part and a plurality of functional parts, which functional parts contain the handle pivot bearing and an electronic component, the functional parts being plugged together with the grip part, and the electronic component being positioned in a cavity of the grip part and having an end plug which is disposed in the region of the pivot bearing.

A handle of the type in question is known from DE 199 22 222 A1, the cavity for the electronic component extending from that side of the grip part which is located opposite the handle pivot bearing. The cavity is closed by the functional element configured as a handle pin. A cable extending from the electronic component is routed through the entire grip part as far as the handle-pivot-bearing end of the same. There, it is coupled to the handle-pivot-bearing functional part via a plug coupling. The cable, which passes through this functional part, then carries a plug toward the outside of the pivot bearing. Such a handle is constructed in a number of parts. This results, in particular, in costly production and assembly of the handle.

Furthermore, it is known from DE 199 43 986 A1 to assemble the grip part from two shells. As long as one shell has not been fitted, the electronic component can be inserted into the shell which forms the handle pin and handle pivot bearing. The cover shell can then be placed in position. This design also involves high outlay to produce. EP 1 067 257 A1 likewise discloses a handle in which a cavity which passes through the grip the cable and then the electronic element are introduced into the cavity. That end of the cable which comes out of the handle-pivot-bearing end carries the plug.

DE 196 17 038 A1 then describes a handle with a grip part which is likewise of shell-like configuration. The lower shell carries the handle pivot bearing and the handle pin. The electronic component is positioned in the lower part and is covered by the upper handle shell. This version has the same disadvantages as DE 199 43 986 A1.

It is the object of the subject matter of the invention to optimize a handle of the generic type in respect of production and assembly.

This object is achieved first and foremost in the case of a handle having the features of claim 1, this being based on the fact that the electronic component is plugged into the handle cavity through a pivot-bearing-side opening of the handle part, and this opening is closed by the functional part forming the handle pivot bearing.

The subject matters of the rest of the claims are explained hereinbelow with reference to the subject matter of claim 1, but may also be important in respect of their independent wording.

Such a configuration provides a handle, in particular for motor vehicle doors, which allows cost-effective production and gives rise to assembly-related advantages. The handle itself is in two parts. These parts are formed by the grip part and the functional part. This fact makes it possible for the handle cavity to extend from the side which is directed toward the handle pivot bearing. The electronic component is inserted from this side. The plug may be an integral constituent part of a plug-in section which has, or is connected to, the electronic component. The contacts of the plug may then be connected to the electronic components by means of leads in the form of stamped components. As an alternative to this solution, it is also provided that the electronic component is connected to the plug by a cable. The plug is seated at a free end of the cable, which passes out of the cavity in the pivoting region of the handle. The cable thus projects out of the handle from the plug-in side for the electronic component. Accordingly, the plug is preferably located in the region where the plug connection usually takes place. It is not necessary, as in the prior art, for the cable to be routed through the entire handle part. This also results in simplified production. Once the electronic component has been inserted, the opening of the handle cavity is closed by the functional part forming the handle pivot bearing. This particular two-part nature of the handle allows the grip part to be worked on separately. The handle-pivot-bearing functional part and the electronic component can be produced in a decentralized manner in relation to the grip part. The corresponding functional parts can then be plugged together. This means that, for example if the coating of the design part, that is to say of the grip part, is defective, it is only the grip part, rather than the entire handle, which is disposed of. The assembly is optimized on account of the fact that the electronic component and the handle-pivot-bearing functional part form a preassembled unit. This results in further simplification of the assembly since it is exclusively during the assembly of the handle that the unit need be associated with the grip part, to be precise by way of plug-in assembly. At the location where the handle is assembled, that is to say where the design and functional parts are joined together, there is no need for any expensive production installations, e.g. for a soldering process or for encapsulation by injection molding. Any waste is minimized as a result of this fact. This unit comprising the electronic component and the handle-pivot-bearing functional part is plugged into the curved cavity, which follows the arcuate shape of the handle. This prevents sticking-out edges or protrusions, which could obstruct insertion. The preassembled unit can easily be realized in that the electronic component and the handle-pivot-bearing functional part are connected to one another rigidly or in a flexible manner via the cable. For selection of the rigid connection, it proves to be advantageous if one or more electronic component are positioned in pockets of a plug-in section of the handle-pivot-bearing functional part. Depending on the initiation of the electronic component, the pockets may be oriented toward the inside or outside of the handle. For example, initiation by a switch is possible. Sensor-based initiation when the handle is gripped would also be possible. In this case, the configuration in which the pockets are oriented toward the inside of the handle is preferably provided. In order to achieve a sealed termination following the plug-in assembly, the plug-in section of the handle-pivot-bearing functional part, this section closing the cavity, is welded or adhesively bonded to the cavity opening. As an alternative, it is possible for the plug-in section of the handle-pivot-bearing functional part, this section closing the cavity, to be latched, clipped or releasably connected to the cavity opening. Such a releasable latching connection is advantageous for final testing. Should a defect then be determined, it would be possible to remove and/or exchange the electronics.

Exemplary embodiments of the invention are explained hereinbelow with reference to the drawings, in which:

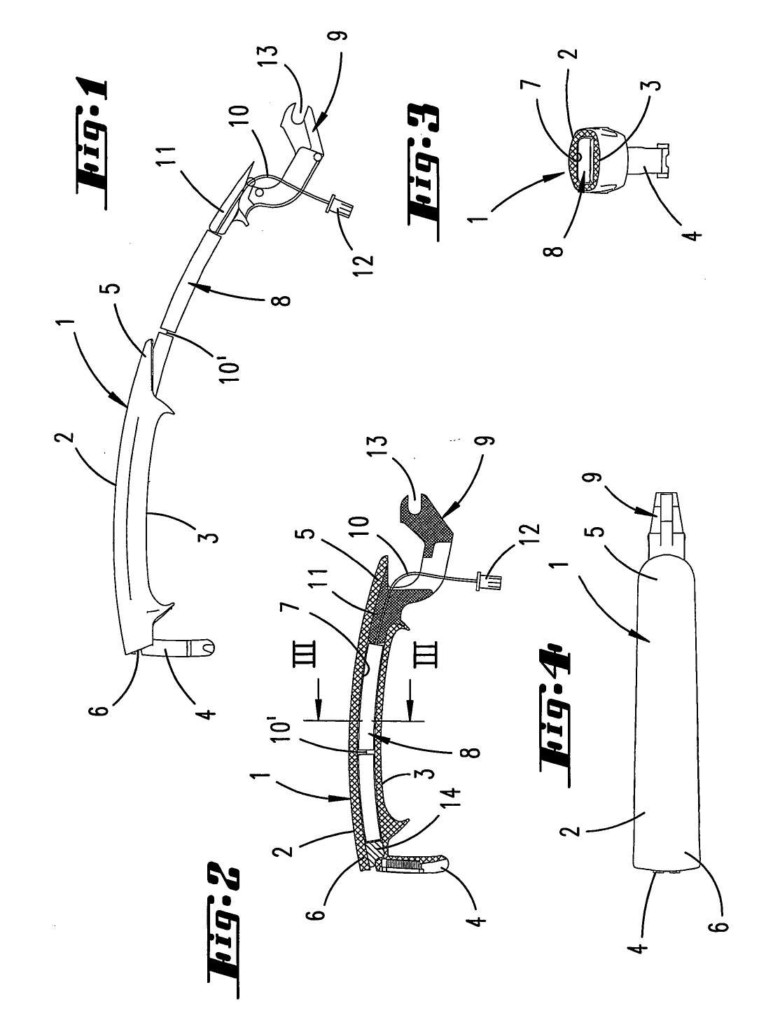

FIG. 1 shows a view of a handle configured according to the invention during the plug-in assembly,

FIG. 2 shows a longitudinal section through the handle in the assembled state,

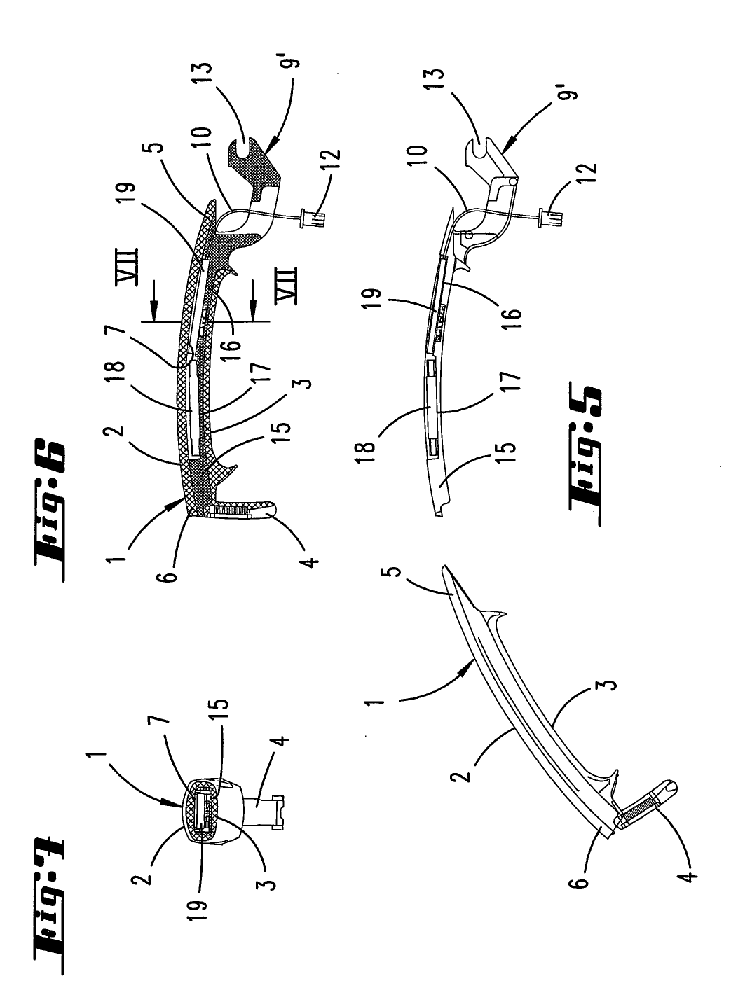

FIG. 3 shows the section along line III-III in FIG. 2,

FIG. 4 shows a plan view of the handle,

FIG. 5 shows a view of the handle prior to the plug-in assembly being carried out, this time relating to a second embodiment,

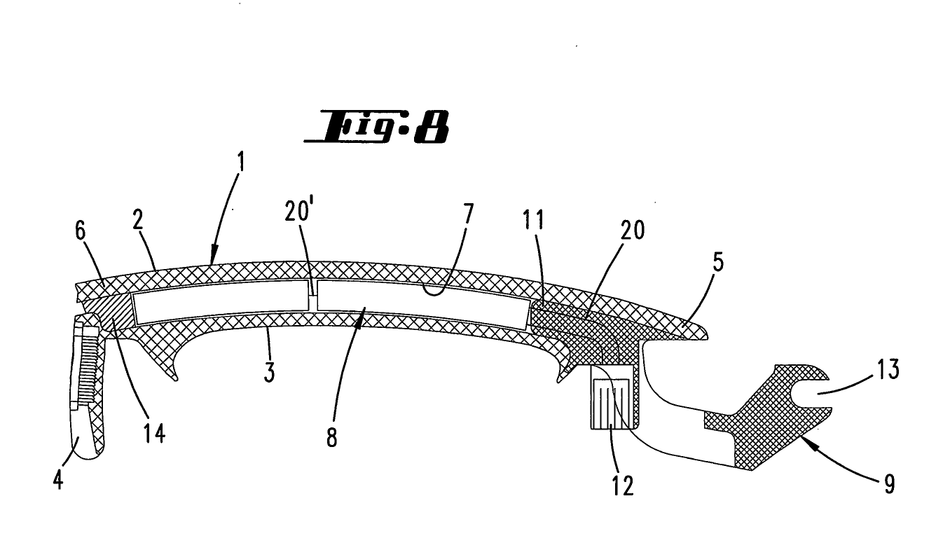

FIG. 6 shows a longitudinal section through the handle in the assembled state,

FIG. 7 shows the section along line VII-VII in FIG. 6, and

FIG. 8 shows a third exemplary embodiment of the invention in an illustration according to FIG. 2.

Both configurations have in common the fact that the handles are used in combination with a keyless entry system. In the case of this locking system, the user of the motor vehicle carries around a chip card, which can be interrogated for locking authorization by means of wireless data transmission by way of a transmitting/receiving device of the motor vehicle.

The handle according to the first embodiment in FIGS. 1 to 4 has a visible and grippable part 1 consisting of suitable plastics material. This grip part is of arcuate configuration and has the convex outer handle side 2 and concave inner handle side 3. One end 6 of the grip part 1 continues integrally into a handle pin 4, which is directed transversely to the grip part 1. From the opposite end 5 of the grip part 1, a cavity 7 extends as far as the end 6 of the grip part 1. This cavity follows the arcuate shape of the handle and is thus correspondingly curved.

In addition to the handle pin 4, further functional parts are associated with the grip part 1. These include an electronic component 8 and a handle-pivot-bearing functional part 9. A cable 10 extends from the electronic component 8, this cable passing through a plug-in section 11 of the handle-pivot-bearing functional part 9 and carrying a plug 12 at the end which is routed outward. The free end of the handle-pivot-bearing functional part 9 forms a fork opening 13. There, the handle is pivotably mounted on the bodywork in a known manner. The plug-in section 11 has its cross-section adapted to that of the cavity 7. A water-tight and dust-proof termination is achieved in this way. The relevant plug-in section 11 here is suitably welded or adhesively bonded to the cavity opening. It is also the case that the opposite end of the cavity 7 is covered in a dust-proof and water-tight manner, for example by a plug 14 there.

As can be seen from FIG. 1 in particular, the electronic component 8 and the handle-pivot-bearing functional part 9 form a preassembled unit, these being connected to one another in a flexible manner via the cable or the cable section 10′, and the unit, which can be produced separately from the grip part 1, being capable of being associated with the grip part by way of the plug-in assembly.

The same parts of the handle which are illustrated in FIGS. 5 to 7 are provided with the same designations. In contrast to the first embodiment, an extended plug-in section 15 is provided here. The length of this section corresponds to the length of the cavity 7. The plug-in section 15 runs in a curved manner in accordance with the cavity 7. From its upper side against two pockets 16 and 17 which are located one behind the other and serve for accommodating electronic components 18, 19 disposed one behind the other. Together with the handle-pivot-bearing functional part 9, these components form a structural unit, the parts of which are connected rigidly to one another. During the assembly or “marriage” of the grip part 1 and the handle-pivot-bearing functional part 9′, the plug-in section 15, which accommodates the electronic components 18, 19, is pushed into the cavity 7 of the grip part 1. Once it has been pushed in, connection then takes place, for example by welding, adhesive bonding or also latching.

In the case of the exemplary embodiment which is illustrated in FIG. 8, the plug 12 is an integral constituent part of the plug-in section 11. The contacts of the plug 12 can be connected to the electronic component 8 via stamped leads. These leads 20 formed by stamped parts may be molded into the material of the plug-in section 11. It is also possible for the conductive connections 20′ between two electronic components to be realized by stamped connecting leads.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1-11. (canceled)

12. Handle, suitable for a motor vehicle door, having a visible and a grip part (1) and a plurality of functional parts, which functional parts comprise a handle pivot bearing (9, 9′) and an electronic component (8; 18, 19), the functional parts being plugged together with the grip part (1), and wherein the electronic component is positioned in a cavity (7) of the grip part (1) and has a plug (12) disposed in a region of the pivot bearing; wherein the electronic component (8; 18, 19), which is fixedly connected to the plug (12), is plugged into the handle cavity (7) through a pivot-bearing-side opening of the grip part (1), and this opening is closed by a functional part forming the handle pivot bearing (9, 9′).

13. Handle according to claim 12, wherein the electronic component (8; 18, 19) and the handle-pivot-bearing functional part (9, 9′) form a preassembled unit.

14. Handle according to claim 12, wherein the electronic component (8; 18, 19) and the handle-pivot-bearing functional part (9, 9′) are plugged in a curved cavity (7) which follows an arcuate shape of the handle.

15. Handle according to claim 12, wherein the electronic component (8, 18, 19) and the handle-pivot-bearing functional part (9, 9′) are connected to one another rigidly or in a flexible manner via a cable connecting the electronic component (8; 18, 19) to the plug.

16. Handle according to claim 12, wherein one or more electronic components (18, 19) are positioned in pockets (16, 17) of a plug-in section (15) of the handle-pivot-bearing functional part (9′).

17. Handle according to claim 16, wherein the pockets (16, 17) are oriented toward the inside or outside of the handle.

18. Handle according to claim 12, wherein a plug-in section (11, 15), which closes the cavity (7), is welded or adhesively bonded to the cavity opening.

19. Handle according to claim 18, wherein the plug-in section (11, 15), which closes the cavity (7), is latched, clipped or releasably connected to the cavity opening.

20. Handle according to claim 12, wherein the plug is connected to the electronic component (8; 18, 19) by a cable (10) which is routed outward in the region of the pivot bearing and has the plug at its free end.

21. Handle according to claim 16, wherein the plug (12) is an integral constituent part of the plug-in section.

22. Handle according to claim 12, wherein contacts of the plug (12) are connected to the electronic component (8; 18, 19) via a metallic leadframe.
